(19) United States
(12) Patent Application Publication
(10) Pub. No.: US 2021/0264051 A1
(43) Pub. Date: Aug. 26, 2021

(54) BLOCKCHAIN SYSTEM, BLOCKCHAIN MANAGEMENT APPARATUS, NETWORK CONTROL APPARATUS, METHOD AND PROGRAM

(71) Applicant: NEC Corporation, Minato-ku, Tokyo (JP)

(72) Inventor: Toshio KOIDE, Tokyo (JP)

(73) Assignee: NEC Corporation, Minato-ku, Tokyo (JP)

(21) Appl. No.: 17/252,412

(22) PCT Filed: Jun. 26, 2018
(86) PCT No.: PCT/JP2018/024228

§ 371 Date: Dec. 15, 2020

(51) Int. Cl. G06F 21/62; G06F 21/60

(52) U.S. Cl. CPC G06F 21/6227; G06F 2221/2141; G06F 21/602

(57) ABSTRACT

A blockchain system, including: computer resources that can operate as computation nodes of logically divided logical blockchains; a blockchain management apparatus that manages a plurality of logical blockchains configured by the computation nodes; a network control apparatus that controls a network in which the computer resources are arranged, among the plurality of logical blockchains, to permit communication between computation nodes which belong to the same logical blockchain and to prohibit communication between computation nodes each of which belongs to a different logical blockchain.

This application is a National Stage Entry of PCT/JP2018/024228 filed on Jun. 26, 2018, the contents of all of which are incorporated herein by reference, in their entirety.

### FIELD

The present invention relates to a blockchain system, blockchain management apparatus, a network control apparatus, a method and a program.

### BACKGROUND

PATENT LITERATURE 1 discloses a block generation apparatus to be able to generate blockchain data of a digital virtual currency that is safer and has higher reliability. The blockchain generation apparatus 1 includes a parameter calculator 122, a block generation condition checker 125 and a blockchain generator 126. Concretely, the parameter calculator 122 identifies a parameter type to be used for linkage of the new block, based on block approval method data 114, and calculates a value for the identified parameter type based on transaction data which are related to an identifier of a generating party. The block generation condition checker 125 determines whether the generating party is qualified to generate the new blockchain data, based on the value calculated by the parameter calculator 122. The blockchain generator 126 then tries to generate the new blockchain when the block generation condition checker 125 determines that the generating party is qualified.

Recently, many virtual currencies such as Bitcoin (Japanese registered trademark) and Ethereum (Japanese registered trademark) traded on an exchange are built on a public type blockchain. The public type blockchain is operated by a plurality of nodes, and it is considered that the blockchain is neutral and can guarantee transparency and tamper resistance of data unless the operators of those nodes acquire majority of authorities.

PATENT LITERATURE 1: Japanese Patent Kokai Publication No. JP-P2017-1148A

### SUMMARY

The following analysis has been made by the present invention. Application of the above-mentioned blockchain to medical fields such as electronic medical records and public fields such as electronic voting is being studied in the future, and there is a case where it may be desired to partially hide data depending on the application. Also, if sufficient security measures are not taken, nodes configuring a blockchain may be infected with malware. In such a case, there is a request to reduce the risk of leakage of data from the configuration nodes.

It is an object of the present invention to provide a blockchain system, a blockchain management apparatus, a network control apparatus, a method and a program that can contribute to improvement of the confidentiality of data flowing in the blockchain and reduction of the risk of data leakage.

According to a first aspect, there is provided a blockchain system, including: computer resources that can operate as computation nodes (mining nodes) of logically divided logical blockchains; a blockchain management apparatus; and a network control apparatus. More concretely, the blockchain management apparatus manages a plurality of logical blockchains configured by the computation nodes. The network control apparatus then controls a network in which the computer resources are located, among the plurality of logical blockchains, to permit communication between computation nodes which belong to the same logical blockchain and to prohibit communication between computation nodes each of which belongs to a different logical blockchain.

According to a second aspect, there is provided a blockchain management apparatus and a network control apparatus which are constituent elements of the blockchain system.

According to a third aspect, there is provided a blockchain management method, including: by a network control apparatus connected to computer resources that can operate as computation nodes of logically divided logical blockchains, receiving information of a plurality of logical blockchains configured by the computation nodes; and controlling a network in which the computer resources are located, among the plurality of logical blockchains, to permit communication between computation nodes which belong to the same logical blockchain and to prohibit communication between computation nodes each of which belongs to a different logical blockchain. The present method is tied to a particular machine, namely, a network control apparatus that controls a network in which the computer resources configuring the computation nodes of the above blockchain are located.

According to a fourth aspect, there is provided a program, causing a computer which configures a network control apparatus connected to computer resources that can operate as computation nodes of logically divided logical blockchains, to execute processing, comprising: receiving information of a plurality of logical blockchains configured by the computation nodes; and controlling a network in which the computer resources are located, among the plurality of logical blockchains, to permit communication between computation nodes which belong to the same logical blockchain and to prohibit communication between computation nodes each of which belongs to a different logical blockchain. It is noted that this program can be recorded on a computer readable (non-transient) storage medium. That is, the present invention can be realized as a computer program product.

According to the present invention, it is possible to contribute to improvement of the confidentiality of data flowing in the blockchain and reduction of the risk of data leakage.

### BRIEF DESCRIPTION OF DRAWINGS

FIG. 1 illustrates a configuration of an exemplary embodiment.

FIG. 2 illustrates a configuration of a blockchain system according to a first exemplary embodiment of the present invention.

FIG. 3 illustrates a configuration of a blockchain management apparatus according to the first exemplary embodiment of the present invention.

FIG. 4 illustrates an example of information held by the blockchain management apparatus according to the first exemplary embodiment of the present invention.

FIG. 5 illustrate a configuration of a network control apparatus according to the first exemplary embodiment of the present invention.

FIG. 6 illustrates an example of information held by the network control apparatus according to the first exemplary embodiment of the present invention.

FIG. 7 is a sequence diagram illustrating an operation of the blockchain system according to the first exemplary embodiment of the present invention.

FIG. 8 illustrates an operation of the blockchain system according to the first exemplary embodiment of the present invention.

FIG. 9 illustrates an operation of the blockchain system according to the first exemplary embodiment of the present invention.

FIG. 10 illustrates an operation of the blockchain system according to the first exemplary embodiment of the present invention.

FIG. 11 illustrates an example of information held by a blockchain management apparatus according to a second exemplary embodiment of the present invention.

FIG. 12 illustrates a configuration of a computer configuring a virtual blockchain system of the present invention.

### PREFERRED MODES

First, an outline of an exemplary embodiment will be described with reference to a drawing. In the following outline, reference signs of the drawings are denoted to each element as an example for the sake of convenience to facilitate understanding and are not intended to limit the present invention to modes illustrated in these drawings. Further, connection lines between blocks in the drawings include both. bidirectional and unidirectional. The one-way arrow schematically shows the flow of a main signal (data), and it does not exclude bidirectionality.

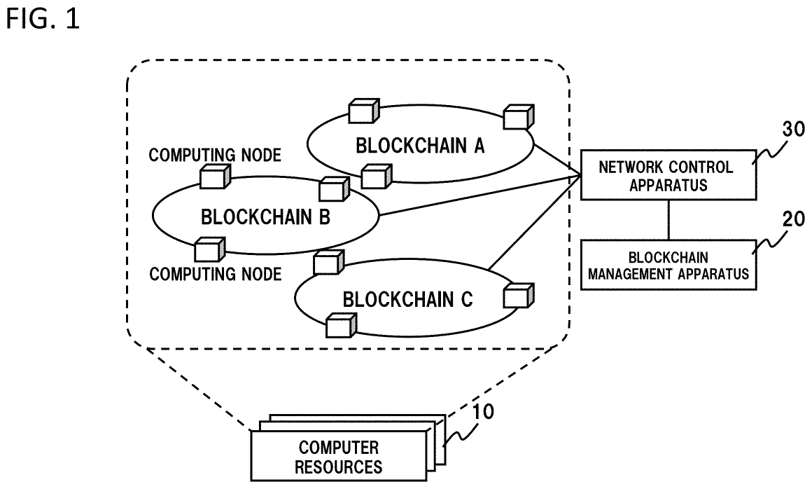

In one exemplary embodiment, as shown in FIG. 1, the present invention can be realized by a blockchain system including computer resources 10, a blockchain management apparatus 20, and a network control apparatus 30.

More concretely, the computer resources 10 are computers, blade servers, or the like that can operate as computation nodes (mining nodes) of a logically divided logical blockchain

The blockchain management apparatus 20 manages a plurality of logical blockchains configured by the computation nodes. For example, the blockchain management apparatus 20 manages the computation nodes (mining nodes) of the (logical) blockchain A, the (logical) blockchain B, and the (logical) blockchain C as shown in FIG. 1. Here, the blockchains A to C may be blockchains for virtual currency, or may be blockchains for traceability management, medical care, and public use. In the following description, the logical blockchain is also simply referred to as a blockchain.

Then, the network control apparatus 30 controls the network in which the computer resources are arranged. Concretely, the network control apparatus 30 controls, among the plurality of logical blockchains, to permit communication between computation nodes which belong to the same logical blockchain and to prohibit communication between computation nodes each of which belongs to a different logical blockchain. For example, the network control apparatus 30 permits communication between the computation nodes belonging to the blockchain A. On the other hand, the network control apparatus 30 prohibits communication between the computation node(s) belonging to the blockchains A and computation node(s) belonging to the other blockchains and/or C.

According to the above configuration, as shown in FIG. 1, it becomes possible to cause the blockchain A, the blockchain B, and the blockchain C to operate as if they were independent blockchains, respectively. As a result, improvement of confidentiality of data flowing through blockchains is achieved. Further, even if any one of the computation nodes belonging to a blockchain is infected with malware or the like, it is possible to limit a range from which data leaks.

### First Exemplary Embodiment

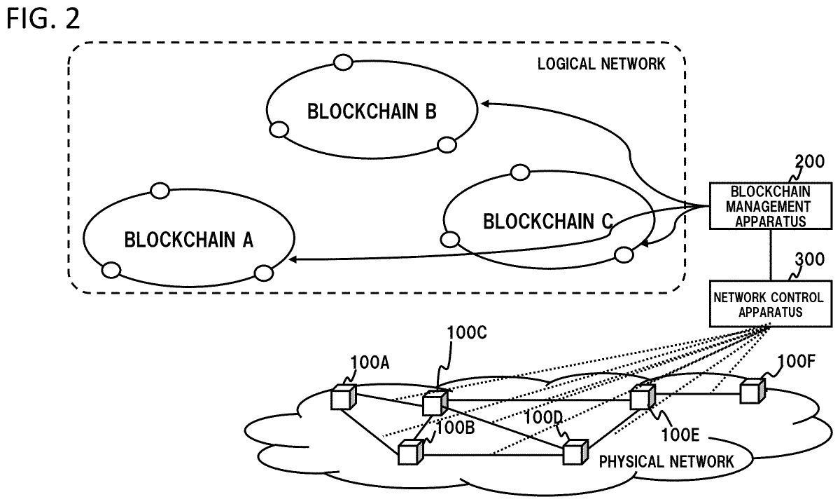

A first exemplary embodiment will be described in detail with reference to the drawings. FIG. 2 illustrates a configuration of a blockchain system according to the first exemplary embodiment of the present invention. With reference to FIG. 2, a configuration including a network control apparatus 300 that controls a physical network in which the computers 100A to 100F are arranged and a blockchain management apparatus 200 that provides the network control apparatus 300 with information about a blockchain is shown. Hereinafter, the computers 100A to 100F will be referred to as “a computer 100” unless they are not distinguished from one another.

As the physical network, a network between bases that connects data centers or the like in which the computers 100A to 100F are located is assumed. Of course, it is not particularly limited as long as it is a network that can execute a consensus procedure regarding the blockchain. For example, some of the computers 100 may be connected to other computers 100 through the Internet.

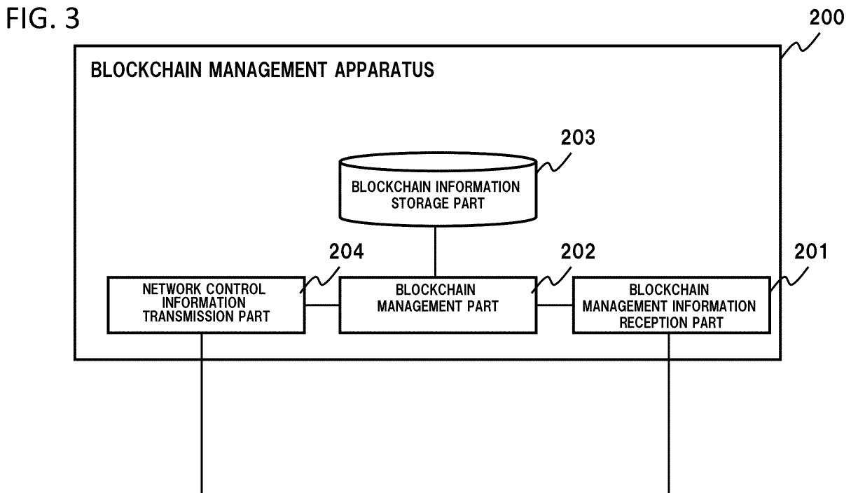

FIG. 3 illustrates a configuration of a blockchain management apparatus 200. With reference FIG. 3, a configuration including a blockchain management information reception part 201, a blockchain management part 202, a blockchain information storage part 203, and a network control information transmission part 204 is shown.

The blockchain management information reception part 201 receives information about a change of a blockchain from the computer 100, a blockchain administrator, or the like, and sends it to the blockchain management part 202. The information about a change of a blockchain includes establishment of a new blockchain, participation of certain computation node(s) in a blockchain, and withdrawal of certain computation node(s) from a blockchain.

The blockchain management part 202 updates blockchain information in the blockchain information storage part 203 based on the information about the change of the blockchain received from the blockchain management information reception part 201. Further, the blockchain management part 202 requests the network control information transmission part 204 to transmit network control information indicating the control content of the network based on the updated blockchain information. The control content of this network permit communication within the blockchain and to prohibit communication between blockchains.

The blockchain information storage part 203 holds information about a blockchain to (a blockchain information) configured using the computer 100. Various types can be taken as types of the blockchain

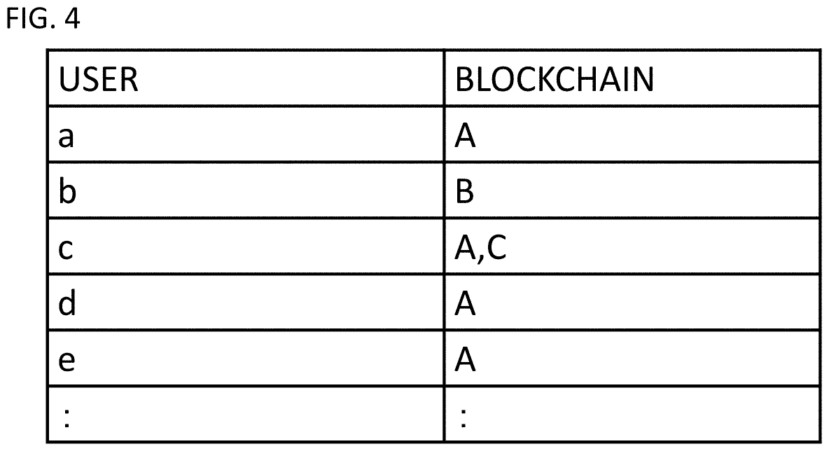

FIG. 4 is an example of blockchain information in an access control list (ACL) format that defines a corresponding relationship between a user and a blockchain to which the user belongs. “User” in FIG. 4 indicates user or owner information of the computer 100. In the example of FIG. 4, it is shown that the computer 100A of a user “a” is participating in the blockchain A. Also, like a user “c”, one user can participate in a plurality of blockchains. Although omitted in the example of FIG. 4, in addition to a name of a blockchain a type of a consensus algorithm used, height information of a block, and the like can be retained as the information of a blockchains, and be provided to a user or a blockchain administrator.

In a case where the blockchain information is such thing as shown in FIG. 4, the blockchain management part 202 requests the network control apparatus 300 to permit communication between the users a, c, d, and e. On the other hand, the communication between the user b participating in the blockchain B and the users a, c, d, and e is prohibited. By doing so, as shown in the upper part of FIG. 2, a plurality of blockchain are logically constructed while each of which is in an independent form.

The network control information transmission part 204 transmits the network control information received from the blockchain management part 202 tothe network control apparatus 300. This network control information may be information about a blockchain for which communication is permitted or information about a combination of blockchains for which communications are prohibited. Alternatively, instead of such information of a blockchain(s), the blockchain management part 202 or the network control information transmission part 204 may rewrite it with information indicating combination of a computation node(s) or a communication port(s) for which communication is permitted. By doing so, it is possible to reduce a load on the network control apparatus 300 side.

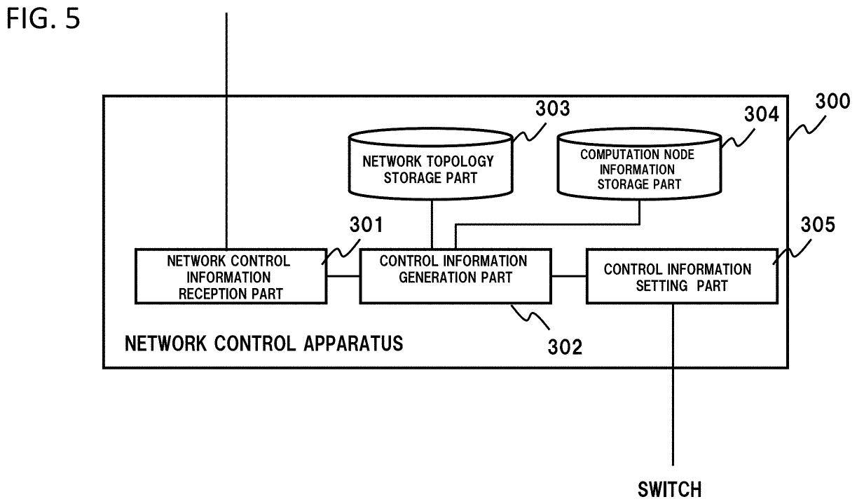

Next, the network control apparatus 300 that controls the network based on an instruction from the blockchain management apparatus 200 will be described. FIG. 5 illustrate a configuration of a network control apparatus 300. With reference to FIG. 5, a configuration including a network control information reception part 301, a control information generation part 302, a network topology storage part 303, a computation node information storage part 304, and a control information setting part 305 is shown.

The network control information reception part 301 receives network control information from the blockchain management apparatus 200.

The control information generation part 302 calculates routes for achieving communication between users indicated in the network control information with reference to the network topology retained in the network topology storage part 303 and the computation node information retained in the computation node information storage part 304. For example, in a case where the information of users belonging to a blockchain A is received as the network control information, the control information generation part 302 identifies the computation node(s) corresponding to appropriate user(s) and connection switched thereof from the computation node information. Next, the control information generation part 302 calculates the communication route between the computation node(s) that is a start point and an end point between the connection switches. Further, the control information generation part 302 generates control information using an address of the computation node information retained in the computation node information storage part 304 to identify the communication between the computation nodes.

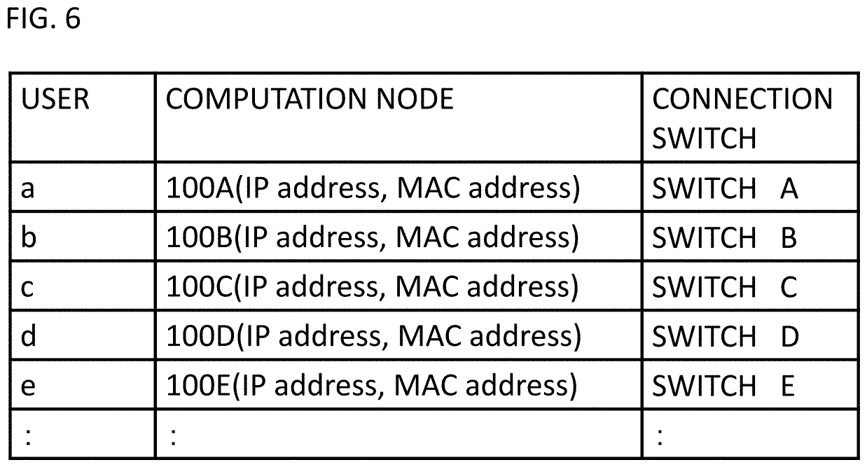

FIG. 6 is an example of the computation node information retained in the computation node information storage part 304. In the example of FIG. 6, an entry is shown in which a user, a computation node thereof, and connection switch information indicating a connection switch or the like to which the computation node is connected, are associated with An IP (Internet Protocol) address and a MAC (Media Access Control) address in parentheses in the computation node are used for a matching condition of the control information generated by the control information generating part 302.

The control information setting part 305 sets the control information generated by the control information generating part 302 in the switch(es) on the route(s).

As can be understood from the above description, the network control apparatus 300 has a function equivalent to that of a control apparatus such as an OpenFlow controller or an SDN (Software Defined Network) controller. Therefore, the network control apparatus 300 can be realized by adding a function for achieving communication in a blockchain based on these apparatuses. In this case, a relay apparatus(es) that relays data between computer resources is(are) arranged in the network which is controlled by the network control apparatus 300. Then, the network control apparatus 300 controls a flow of data between computer resources by controlling a relay apparatus that relays data between computer resources. Concretely, the network control apparatus 300 sets control information that permits communication between computation nodes belonging to the same blockchain among a plurality of blockchains.

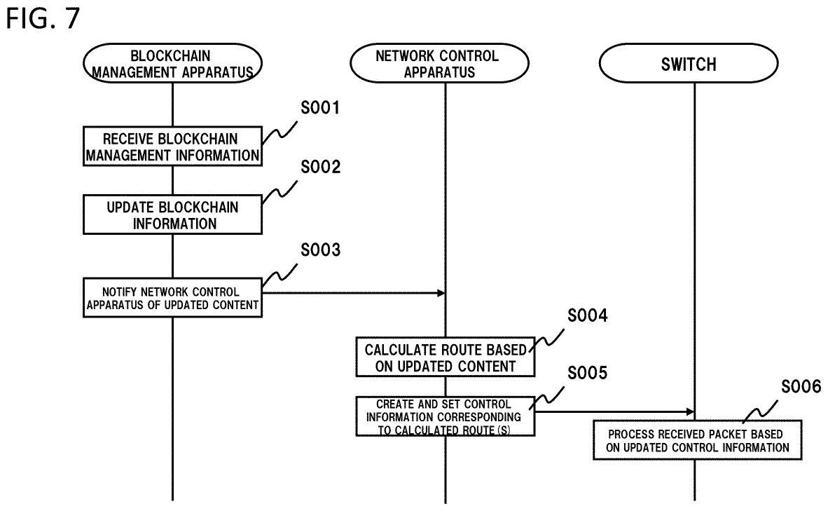

Next, the operation of this exemplary embodiment will be described in detail with reference to the drawings. FIG. 7 is a flow chart illustrating an operation of the blockchain system according to the first exemplary embodiment of the present invention. With reference to FIG. 7, first, the blockchains management apparatus 200 receives blockchain management information from outside (step S001).

Next, the blockchain management apparatus 200 updates blockchain information based on the received blockchain management information (step S002).

Next, the blockchain management apparatus 200 notifies the network control apparatus 300 of an updated content of the blockchain (step S003). For example, when the user x newly participates in a blockchain A, the blockchain management apparatus 200 transmits to the network control apparatus 300 network control information indicating that the user x has been added to the blockchain A.

The network control apparatus 300 calculates a route based on the received network control information (step S004). Concretely, the network control apparatus 300 calculates route(s) between the computation nodes corresponding to the user x and the computation nodes respectively corresponding to the users a, c, d, and e.

Next, the network control apparatus 300 creates control information corresponding to the calculated route(s) and sets them in switches or the like on the route(s) (step S005).

The switch that received the setting of the control information transfers the packet between the computation nodes according to the control information. As a result, communication within the same blockchain is realized.

By using a switch having a function of discarding a packet that does not match the control information as a switch between the computation nodes, communication between different blockchains can be prohibited. Of course, if the switch or the like does not have such a function, control information for prohibiting communication between different blockchains may be explicitly set.

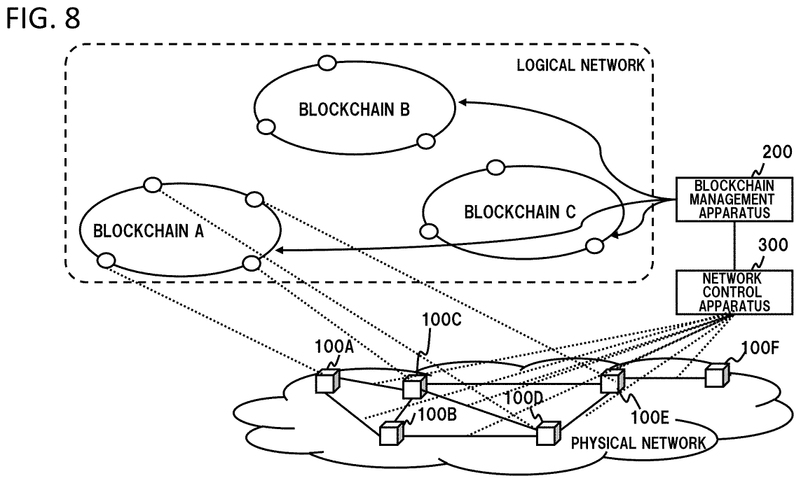

It will be described with reference to FIGS. 8 to 10 that a logically divided blockchain is configured by the above operation.

First, when information on the blockchain A is input to the blockchain management apparatus 200, the blockchain management apparatus 200 updates blockchain information and sends network control information to the network control apparatus 300.

The network control apparatus 300 that has received the network control information sets control information for realizing the communication between the computers 100 corresponding to the blockchain A, as shown in FIG. 8. This enables communication between computers that function as computation nodes in the blockchain A, which is enabled to operate as a blockchain.

Next, when the information on the blockchain B is input to the blockchain management apparatus 200, the blockchain management apparatus 200 updates blockchain information and sends the network control information to the network control apparatus 300.

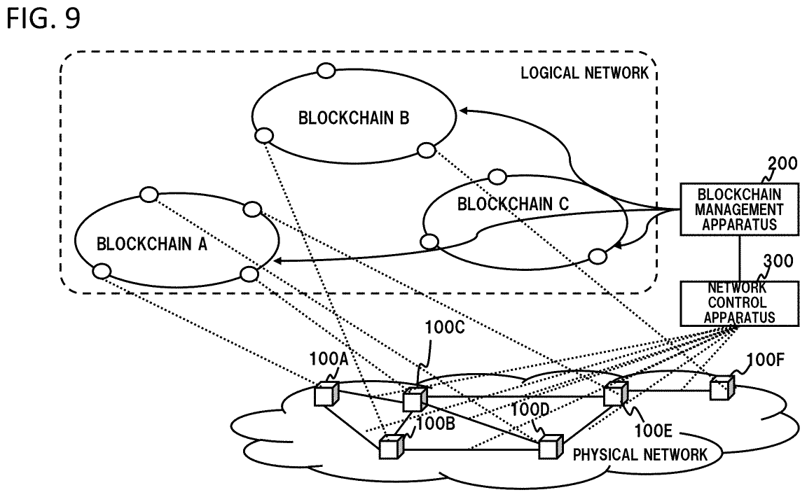

The network control apparatus 300 that has received the network control information sets control information for realizing the communication between the computers 100 corresponding to the blockchain B, as shown in FIG. 9. This enables communication between computers that function as computation nodes in the blockchain B, which is enabled to operate as a blockchain. However, since control information for realizing the communication between the blockchain A and the blockchain B is not created or control information for discarding the corresponding communication is set, the communication between the blockchain A and the blockchain B is prohibited.

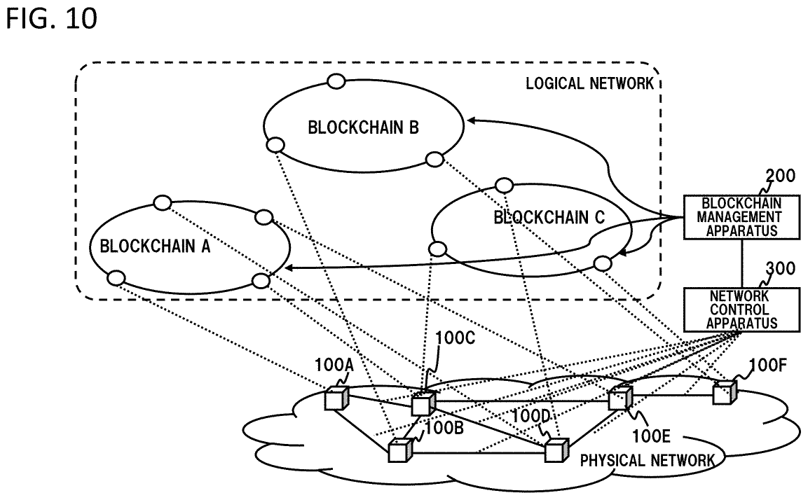

Next, the same applies when information on the blockchain C is input to the blockchain management device 200, and as shown in FIG. 10, the network control device 300 sets control information for realizing the communication between the computers 100 corresponding to the blockchain C.

As described above, operation of the blockchain management apparatus 200 and the network control apparatus 300 has been described hereinabove using the case where the blockchain information is updated on a blockchain basis, but the same applies when a new computation node participates in the blockchain. That is, when a new computation node participates, the blockchain management information that the new computation node has participated is input to the blockchain management apparatus 200, and the blockchain information is updated. Then, the network control apparatus 300 calculates the route(s) between the newly participated computation node and the other computation node(s), and sets the control information, whereby the computation node is added to the blockchain.

The same applies when a computation node withdraws from a particular blockchain, and the blockchain information is updated. Then, the network control apparatus 300 deletes the control information that has realized the communication between the withdrawing computation node and other computation node(s), so that the computation node is deleted from the blockchains. Of course, if the control information is set to be deleted due to a time-out or the like, such process is not necessary upon withdrawal of the computation node.

As described above, each of exemplary embodiments of the present invention has been described. However, the present invention is not limited to the above-described exemplary embodiments, and further modifications, substitutions, and adjustments made without departing from the basic technical concept of the present invention can be added to. For example, the network configuration, the configuration of each element, and the expression form of a message illustrated in each drawing are examples for helping the understanding of the present invention and are not limited to the configurations illustrated in these drawings. In the following a description, “A and/or B” is used to mean at least one of A or B.

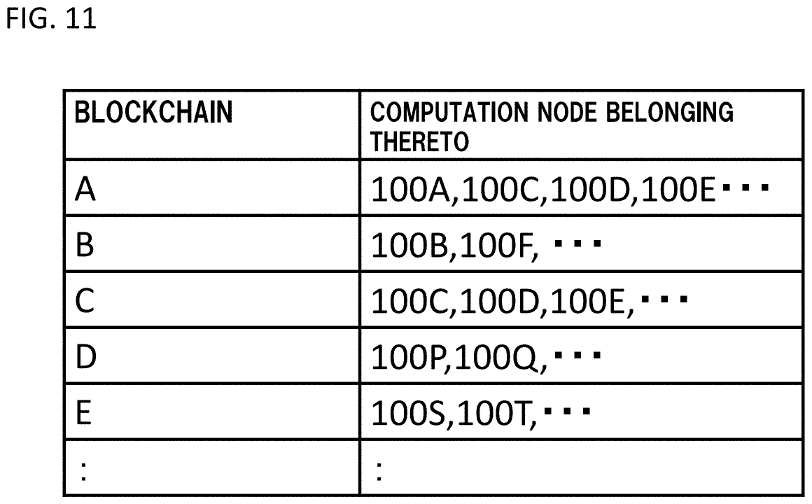

For example, in the above-described exemplary embodiments, it is described that the blockchain is managed by using the blockchain information in the access control list (ACL) format, but the mode to manage the information of the blockchain is not limited to this. For example, as shown in FIG. 11, the blockchain may be managed for each blockchain using a table or the like for managing the computation node belonging thereto (a second exemplary embodiment). In this case, the user column of the computation node information shown in FIG. 6 is unnecessary.

In the above-described exemplary embodiments, the physical computer 100 is used for description, but it is also possible to use virtual machines for all or part of the computer 100. In this case, a control device of the virtual machine(s) or the like may bear a function as the blockchain management apparatus 200 (a third exemplary embodiment).

Further, in the above exemplary embodiment, the blockchain management apparatus 200 and the network control apparatus 300 are described as being arranged independently, but it is possible to integrate the blockchain management apparatus 200 and the network control apparatus 300 into the same one apparatus. It is also possible to use a function(s) provided as a network function(s) on the cloud as the blockchain management apparatus 200 and the network control apparatus 300.

Further, in the above-described exemplary embodiments, it is described that each blockchain does not particularly encrypt data, but each blockchain may also encrypt data (a fourth exemplary embodiment). By doing so, it is possible to further secure improvement of the confidentiality of the data flowing, through the blockchain and reduction of the risk of data leakage. Of course, it is not necessary to perform encryption on all the blockchain, and it may be possible that data encryption be performed on at least one blockchain.

Also, instead of above encrypting data, by managing different blockchains not to use the same port, it is possible to further secure improvement of the confidentiality of data flowing in the blockchain and reduction of the risk of data leakage (a fifth exemplary embodiment). For example, a mode is possible in which the network control apparatus 300 calculates routes in which different logical blockchains do not share the ports of the same switch based on network control information received from the blockchain management apparatus 200, and sets, to the switches on these routes, control information corresponding to the routes concerned. Alternatively, as another method, the blockchain management apparatus 200 may send to the network control apparatus 300 information indicating a combination of computation nodes and communication ports that are permitted to communicate as the network information, based on a rule that the different logical blockchain do not use the same port. By doing so, it is possible to reduce the load on the network control apparatus 300 side.

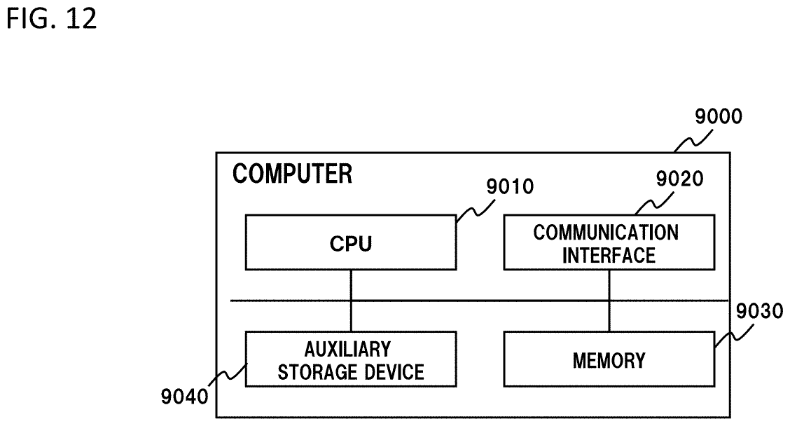

Further, the procedure(s) shown in the above-described exemplary embodiments can be realized by a program that causes a computer (9000 in FIG. 12) that functions as the blockchain management apparatus 200 and the network control apparatus 300 to execute the processings as these apparatuses, respectively. Such a computer is exemplified in the configuration including a CPU (Central Processing Unit) 9010, a communication interface 9020, a memory 9030, and an auxiliary storage device 9040 as shown in FIG. 12. That is, the CPU 9010 of FIG. 12 may execute a data transmission/reception program and a data conversion program and cause to generate the network control information and to generate and set control information with reference to the information held in the auxiliary storage device 9040.

That is, each part (processing part, function) of the virtual blockchain system shown in each of the above exemplary embodiments is realized by a computer program that causes a processor(s) mounted on the computer to execute each of the above processes by using its hardware.

Finally, preferred modes of the invention are summarized.

### [Mode 1]

(Refer to the blockchain system from the above first aspect)

### [Mode 2]

The above blockchain management apparatus can manage a plurality of logical blockchains using an access control list which associates each computation node or user with a blockchain(s) to which the computation node or the user belongs.

### [Mode 3]

It is preferable, in the blockchain system above, that a relay apparatus for relaying data between the computer resources according to control from the network control apparatus is further arranged.

### [Mode 4]

The network control apparatus above can set control information for permitting communication between computation nodes which belong to the same logical blockchain among the plurality of logical blockchains in the relay apparatus to permit communication between computation nodes which belong to the same logical blockchain and to prohibit communication between computation nodes each of which belongs to a different logical blockchain.

### [Mode 5]

It is preferable, in the blockchain system above, that at least one or more logical blockchain(s) among the blockchains perform data concealment by encryption.

### [Mode 6]

The blockchain management apparatus can employ a mode to manage the plurality of logical blockchains using a table which associates each blockchain with information of the computation nodes belonging to the logical blockchain.

### [Mode 7]

(Refer to the blockchain management apparatus from the above second aspect)

### [Mode 8]

(Refer to the network control apparatus from the above second aspect)

### [Mode 9]

According to a third aspect, there is provided a blockchain management method, comprising:
by a network control apparatus connected to computer resources that can operate as computation nodes of logically divided logical blockchains,
receiving information of a plurality of logical blockchains configured by the computation nodes; and
controlling a network in which the computer resources are located, among the plurality of logical blockchains, to permit communication between computation nodes which belong to the same logical blockchain and to prohibit communication between computation nodes each of which belongs to a different logical blockchain.

### [Mode 10]

According to a fourth aspect, there is provided a computer-readable non-transient recording medium recording a program, the program, causing a computer which configures a network control apparatus connected to computer resources that can operate as computation nodes of logically divided logical blockchains, to execute processings, comprising:

receiving information of a plurality of logical blockchains configured by the computation nodes; and
controlling a network in which the computer resources are located, among the plurality of logical blockchains, to permit communication between computation nodes which belong to the same logical blockchain and to prohibit communication between computation nodes each of which belongs to a different logical blockchain.
The seventh to tenth modes can be expanded to the second to sixth modes as is the case with the first mode.

The disclosure of the above patent literature is incorporated herein by reference. Modifications and adjustments of the exemplary embodiments or examples are possible within the framework of the entire disclosure (including the claims) of the present invention and based on the basic technical concept thereof. In addition, various combinations of various disclosed elements (including each element of each claim, each element of each exemplary embodiment or example, each element of each drawing, and the like) or selection are possible within the scope of the entire disclosure of the present invention. That is, the present invention of course includes various variations and modifications that could be made by those skilled in the art according to the entire disclosure including the claims and the technical concept. In particular, with respect to the numerical ranges described herein, any numerical values or small range(s) included in the ranges should be construed as being expressly described even if not otherwise specified.

### REFERENCE SIGNS LIST

10 computer resources
20 blockchain management apparatus
30 network control apparatus
100, 100A-100F computer
200 blockchain management apparatus
201 blockchain management information reception part
202 blockchain management part
203 blockchain information storage part
204 network control information transmission part
300 network control apparatus
301 network control information reception part
302 control information generation part
303 network topology storage part
304 computation node information storage part
305 control information setting part
9000 computer
9010 CPU
9020 communication interface
9030 memory
9040 auxiliary storage device

What is claimed is:

1. A blockchain system, comprising:
computer resources that can operate as computation nodes of logically divided logical blockchains;
a blockchain management apparatus that manages a plurality of logical blockchains configured by the computation nodes;
a network control apparatus that controls a network in which the computer resources are located, among the plurality of logical blockchains, to permit communication between computation nodes which belong to the same logical blockchain and to prohibit communication between computation nodes each of which belongs to a different logical blockchain.

2. The blockchain system according to claim 1,
wherein the blockchain management apparatus manages the plurality of logical blockchains using an access control list which associates each computation node or user with a blockchain(s) to which the computation node or the user belongs.

3. The blockchain system according to claim 1, wherein a relay apparatus for relaying data between the computer resources according to control from the network control apparatus is further arranged.

4. The blockchain system according to claim 3,
wherein the network control apparatus sets control information for permitting communication between computation nodes which belong to the same logical blockchain among the plurality of logical blockchains in the relay apparatus to permit communication between computation nodes which belong to the same logical blockchain and to prohibit communication between computation nodes each of which belongs to a different logical blockchain.

5. The blockchain system according to claim 1,
wherein at least one or more logical blockchain(s) among the plurality of logical blockchains perform data concealment by encryption.

6. The blockchain system according to claim 1,
wherein the blockchain management apparatus manages the plurality of logical blockchains using a table which associates each logical blockchain with information of the computation nodes belonging to the logical blockchain.

7. A blockchain management apparatus, wherein the blockchain management apparatus is connected to:
computer resources that can operate as computation nodes of logically divided logical blockchains; and
a network control apparatus that controls a network in which the computer resources are arranged, among the plurality of logical blockchains, to permit communication between computation nodes which belong to the same logical blockchain and to prohibit communication between computation nodes each of which belongs to a different logical blockchain, and wherein
the blockchain management apparatus manages the plurality of logical blockchains configured by the computation nodes.

8. A network control apparatus, wherein the network control apparatus is connected to:
computer resources that can operate as computation nodes of logically divided logical blockchains; and
a blockchain management apparatus that manages a plurality of logical blockchains configured by the computation nodes, and wherein the network control apparatus controls a network in which the computer resources are located, among the plurality of logical blockchains, to permit communication between computation nodes which belong to the same logical blockchain and to prohibit communication between computation nodes each of which belongs to a different logical blockchain.

9. (canceled)

10. (canceled)

11. The blockchain management apparatus according to claim 7,
wherein the blockchain management apparatus manages the plurality of logical blockchains using an access control list which associates each computation node or user with a blockchain(s) to which the computation node or the user belongs.

12. The blockchain management apparatus according to claim 7,
wherein at least one or more logical blockchain(s) among the plurality of logical blockchains perform data concealment by encryption.

13. The blockchain management apparatus according to claim 7,
wherein the blockchain management apparatus manages the plurality of logical blockchains using a table which associates each logical blockchain with information of the computation nodes belonging to the logical blockchain.

14. The network control apparatus according to claim 8, wherein a relay apparatus for relaying data between the computer resources according to control from the network control apparatus is further arranged.

15. The network control apparatus according to claim 14,
wherein the network control apparatus sets control information for permitting communication between computation nodes which belong to the same logical blockchain among the plurality of logical blockchains in the relay apparatus to permit communication between computation nodes which belong to the same logical blockchain and to prohibit communication between computation nodes each of which belongs to a different logical blockchain.

16. The network control apparatus according to claim 8,
wherein at least one or more logical blockchain(s) among the plurality of logical blockchains perform data concealment by encryption.
